(19) United States
(12) Patent Application Publication
(10) Pub. No.: US 2026/0054483 A1
(43) Pub. Date: Feb. 26, 2026

(54) ELEMENT BOARD

(71) Applicant: CANON KABUSHIKI KAISHA, Tokyo (JP)

(72) Inventor: KOJI TAKASE, Kanagawa (JP)

(21) Appl. No.: 19/289,262

(22) Filed: Aug. 4, 2025

(30) Foreign Application Priority Data
Aug. 26, 2024 (JP) 2024-144432

(51) Int. Cl. B41J 2/14

(52) U.S. Cl. CPC B41J 2/14072; B41J 2/14088

(57) ABSTRACT

Provided is an element board having a multi-layer structure, including: a heater layer; a first wiring layer which has a stacked structure portion of three or more layers sequentially stacked in a conduction direction, in which a wiring connected to a plurality of heaters is formed; and a second wiring layer in which a common wiring for supplying a voltage to the plurality of heaters from an outside is formed, wherein the plurality of heaters are connected to the common wiring through the first wiring layer, the first wiring layer has a stacked structure of three or more layers, and the stacked structure portion includes a corrosion-resistant conductive layer, a first conductive layer, and a second conductive layer.

### BACKGROUND OF THE INVENTION

### Field of the Invention

The present disclosure relates to an element board, a liquid ejection head, and a printing apparatus including the head. Particularly, the present disclosure relates to, for example, a printing apparatus to which a liquid ejection head incorporating an element board in which dissolution by an ink is suppressed is applied as a printing head for conducting printing in accordance with an inkjet system.

### Description of the Related Art

For liquid ejection apparatuses represented by inkjet printing apparatuses, higher image quality and faster speed have been demanded. In general, an inkjet printing system employing a thermal system is a system which generates bubbles in nozzles by locally heating a liquid such as an ink from the nozzles, and ejecting the ink from the nozzles by unit of the bubbles to cause the ink to land onto a printing target. In a printing head of such a system, heating resistance elements for heating a liquid are formed on a semiconductor substrate together with a logical circuit for driving the heating resistance elements. In this way, the printing head meets the aforementioned demands for achieving higher image quality and faster speed, and achieves a high-speed drive by disposing the heating resistance elements at a high density.

In such a printing head, there is a case where an accidental wire break of heating resistance elements on an element board occurs. Since the vicinity of the heating resistance elements on the element board is exposed to an ink, there is a possibility that plugs or electrical wiring layers which are electrically connected to the heating resistance elements are dissolved into the ink, and corrosion progresses at the time of wire break of the heating resistance elements. In addition, in the case where wiring corrosion starting from a certain heating resistance element has largely progressed, and the corrosion has reached wiring portions which are connected to heating resistance elements in the vicinity, there is a possibility that the drives of not only the heating resistance element from which the corrosion has started but also the heating resistance elements in the vicinity are destabilized, thus impeding the normal drive. In recent years, a technology which detects a heating resistance element in which wire break has occurred, and complements the heating resistance element with other normal heating resistance elements has been introduced. However, in the case where heating resistance elements have collectively lost their functions, it becomes difficult to complement these heating resistance elements with other normal heating resistance elements, which can lead to a decrease in image quality.

Japanese Patent Laid-Open No. 2020-179527 (hereinafter, referred to as Document 1) describes a configuration in which one ends of heating resistance elements are connected to a VH common wiring via through-holes which have a small aspect ratio (a ratio between a through-hole height and a through-hole diameter) to have a favorable coverability of barrier metal layers. This configuration makes it possible to suppress the progress of corrosion with the barrier metal layers having a favorable coverability even in the case where wire break has occurred in a heating resistance element.

However, in the case of further reducing the sizes of elements, connection members such as plug are also reduced in size in conjunction with the reduction in size of wirings, which reduces the through-hole diameter, so that the aspect ratio of the through-holes increases.

### SUMMARY OF THE INVENTION

In view of the above-described problems, an object of the present disclosure is to provide an element board, a liquid ejection head, and a printing apparatus, which are capable of suppressing the progress of corrosion of wiring portions connected to heating resistance elements.

An element board of the present disclosure for solving the above-mentioned problem is an element board having a multi-layer structure, having: a heater layer in which a plurality of heaters for ejecting a liquid are formed; a first wiring layer which has a stacked structure portion of three or more layers sequentially stacked in a conduction direction at least in part thereof, a first metal plug which is in contact with the stacked structure portion, and fills an inside of a first through-hole extending toward the heater layer; a second metal plug which is in contact with the stacked structure portion, and fills an inside of a second through-hole extending toward an opposite side from the heater layer; and a second wiring layer in which a common wiring for supplying a voltage to the plurality of heaters from an outside is formed, wherein the plurality of heaters are connected to the common wiring through the first wiring layer, the stacked structure portion includes a corrosion-resistant conductive layer, a first conductive layer, and a second conductive layer, a surface of the corrosion-resistant conductive layer on the heater layer side is in contact with the first conductive layer, a surface of the corrosion-resistant conductive layer on the opposite side from the heater layer is in contact with the second conductive layer, the first metal plug is in contact with the first conductive layer, the second metal plug is in contact with the second conductive layer, the first wiring layer is electrically connected to the heater layer through the first metal plug, and is electrically connected to the common wiring through the second metal plug, and the corrosion-resistant conductive layer is formed of a material having a high corrosion resistance to an ink.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing a schematic diagram of a configuration of a printing apparatus including a printing head which is a representative embodiment of the present disclosure;

FIG. 2 is a block diagram showing a control configuration of the printing apparatus shown in FIG. 1;

FIG. 3 is a diagram showing a layout configuration of an element board (head board) mounted in the printing head;

FIG. 4 is an enlarged view of an X portion of the element board shown in FIG. 3;

FIG. 5 is a diagram showing an equivalent circuit of a drive circuit which drives one heater;

FIG. 6 is a sectional view showing a multi-layer structure of an element board as Comparative Example;

FIG. 7A is a sectional view showing a structure of a through-hole 340, FIG. 7B is a sectional view showing a structure of a through-hole 330, and FIG. 7C is a sectional view showing a structure of a through-hole 320;

FIG. 8 is a sectional view showing a case where corrosion of a wiring portion of an element board progressed;

FIG. 9 is a sectional view showing a multi-layer structure of an element board according to a first embodiment;

FIG. 10 is an enlarged view of a Y portion of the element board shown in FIG. 9;

FIG. 11A is a sectional view of a two-layer configuration A, and FIG. 11B is a sectional view of a two-layer configuration B;

FIG. 12 is a diagram schematically showing how a plug was dissolved by wire break of a heater of the element board shown in FIG. 9;

FIG. 13 is a sectional view showing a multi-layer structure of an element board according to a second embodiment;

FIG. 14 is a sectional view showing a multi-layer structure of an element board according to a third embodiment; and

FIG. 15 is an enlarged view of an XV portion of the element board shown in FIG. 14.

### DESCRIPTION OF THE EMBODIMENTS

Hereinafter, preferred embodiments of the present disclosure will be described more specifically in detail with reference to the attached drawings. Note that the following embodiments are not intended to limit the invention according to Claims. Although a plurality of features are described in the embodiments, all the plurality of features are not necessarily essential for the invention. In addition, the plurality of features may be combined as desired.

Note that in this Specification, the term “printing (also referred to as “print”) does not mean only forming significant information such as a text and a figure, but it does not matter whether or not it is significant or insignificant. In addition, it does not matter whether or not “printing” is so visualized that it can be visually perceived by humans, and “printing” also broadly means forming an image, a design, a pattern, and the like on a printing medium, and also represents the case of processing a medium.

In addition, the term “printing medium” represents not only paper used in general printing apparatuses, but also broadly represents those capable of receiving inks, such as cloth, plastic films, metal plates, glass, ceramics, woods, and leathers.

Moreover, the term “ink” (also referred to as a “liquid”) should be construed as broadly as in the definition of the above-described “printing (print)”. Hence, the ink is assumed to represent a liquid which can be applied onto a printing medium to form an image, a design, a pattern, or the like, process a printing medium, or treat an ink (for example, coagulation or insolublization of a coloring material in the ink applied to a printing medium). Hence, the printing head can also be referred to as an “ink ejection head” or a “liquid ejection head” in general.

Furthermore, the term “nozzle” generally refers to an ejection port and a liquid passage which communicates with the ejection port, as well as an element which generates energy to be used for the ink ejection unless otherwise particularly specified.

An element board (head board) for a printing head used below does not indicate a mere board made of a silicon semiconductor but indicates a configuration in which each element, wiring, and the like are provided.

Moreover, the expression “on aboard” does not only indicate on an element board, but also indicates on a surface of the element board, and an inside of the element board near the surface. In addition, the term “built-in” mentioned in the present disclosure is not a word indicating merely disposing each separate element on the surface of a board as a separate body, but indicates integrally forming and manufacturing each element on an element board by a manufacturing process of a semiconductor circuit or the like.

### (Description of Overview of Printing Apparatus)

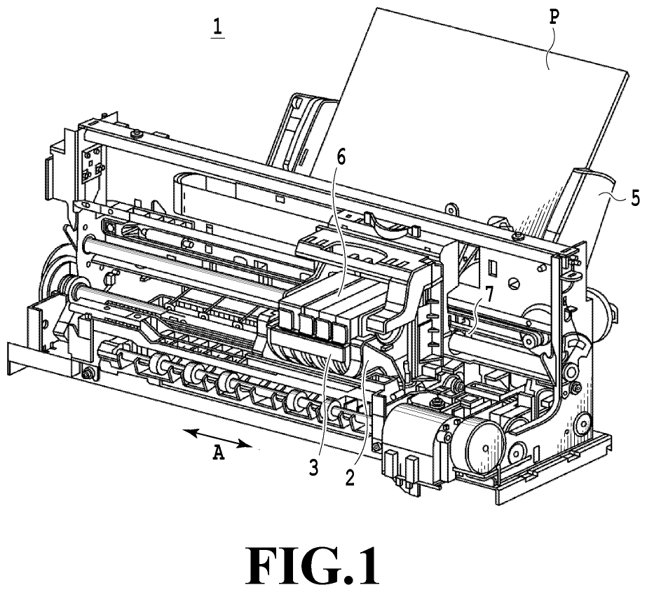

FIG. 1 is an external perspective view showing an overview of a configuration of a printing apparatus which conducts printing by using an inkjet printing head (hereinafter, a printing head) which is a representative embodiment of the present disclosure.

As shown in FIG. 1, an inkjet printing apparatus (hereinafter, a printing apparatus) 1 includes a printing head 3 which conducts printing by ejecting an ink in accordance with an inkjet system and is mounted on a carriage 2. Then, the inkjet printing apparatus 1 conducts printing by reciprocating the carriage 2 in a direction of an arrow A. The printing is conducted by feeding a printing medium P such as print paper with a feeding mechanism 5 and conveying the printing medium P to a printing position, and ejecting the ink from the printing head 3 to the printing medium P at the printing position.

On the carriage 2 of the printing apparatus 1, not only the printing head 3 is mounted, but also an ink tank 6 which contains the ink to be supplied to the printing head 3 is attached. The ink tank 6 can be attached to and detached from the carriage 2.

The printing apparatus 1 shown in FIG. 1 is capable of color printing, and four ink cartridges which store inks of magenta (M), cyan (C), yellow (Y), and black (K), respectively, are mounted on the carriage 2 for this purpose. These four ink cartridges are independent from one another, and can be attached to and detached from the carriage 2.

Since the printing head 3 of this embodiment employs the inkjet system which ejects the inks by using thermal energy, the printing head 3 includes electrothermal conversion elements (heater). This electrothermal conversion element is provided to correspond to each ejection port, and a pulse voltage is applied to the corresponding electrothermal conversion element in response to a printing signal to eject the ink from the corresponding ejection port. Note that the printing apparatus 1 is not limited to the above-mentioned serial-type printing apparatus, and may also be applied to a so-called full line-type printing apparatus in which printing heads (line heads) each having ejection ports arrayed in a width direction of a printing medium are disposed in a conveyance direction of the printing medium.

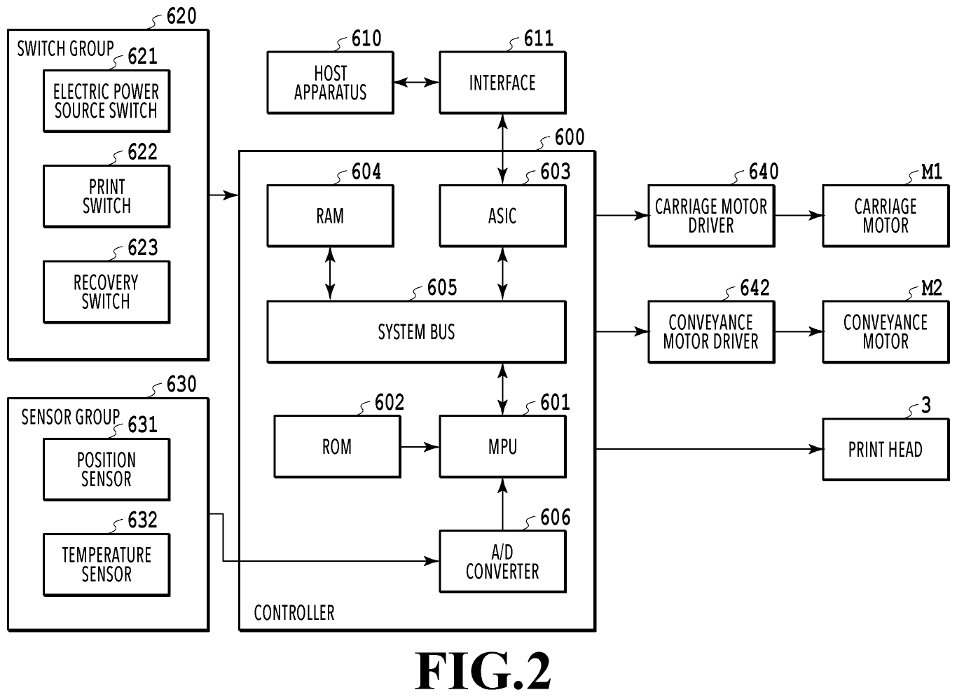

FIG. 2 is a block diagram showing a control configuration of the printing apparatus 1 shown in FIG. 1. As shown in FIG. 2, a controller 600 is configured with an MPU 601, a ROM 602, an application-specific integrated circuit (ASIC) 603, a RAM 604, a system bus 605, an A/D converter 606, and the like. Here, the ROM 602 stores programs corresponding to a control sequence, which will be described later, required tables, and other fixed data. The ASIC 603 generates control signals for controlling a carriage motor M1, for controlling a conveyance motor M2, and for controlling the printing head 3. The RAM 604 is used as a development area for image data, a work area for executing the programs, and the like. The system bus 605 connects the MPU 601, the ASIC 603, and the RAM 604 to one another and communicates data. The A/D converter 606 receives analog signals from a sensor group, which will be described later, and converts the analog signals to digital signals, and supplies the digital signals to the MPU 601.

In addition, in FIG. 2, 610 indicates a host apparatus corresponding to a host or an MFP which serves as an image data supply source. Between the host apparatus 610 and the printing apparatus 1, image data, commands, statuses, and the like are communicated by packet communications via an interface (I/F) 611.

Moreover, 620 indicates a switch group, which is configured with a power supply switch 621, a print switch 622, a recovery switch 623, and the like.

630 indicates a sensor group which detects the state of the apparatus, and which is configured with a position sensor 631, a temperature sensor 632, and the like. In this embodiment, a photosensor which detects an amount of the remaining ink is also provided.

Furthermore, 640 indicates a carriage motor driver which drives a carriage motor M1 for causing the carriage 2 to scan back and forth in the direction of the arrow A, and 642 indicates a conveyance motor driver which drives the conveyance motor M2 for conveying the printing medium P.

The ASIC 603 directly accesses a memory area of the RAM 604 and transfer data for driving the electrothermal conversion elements to the printing head in printing scan by the printing head 3. In addition, this printing apparatus includes a display unit configured with a LCD and LEDs as a user interface.

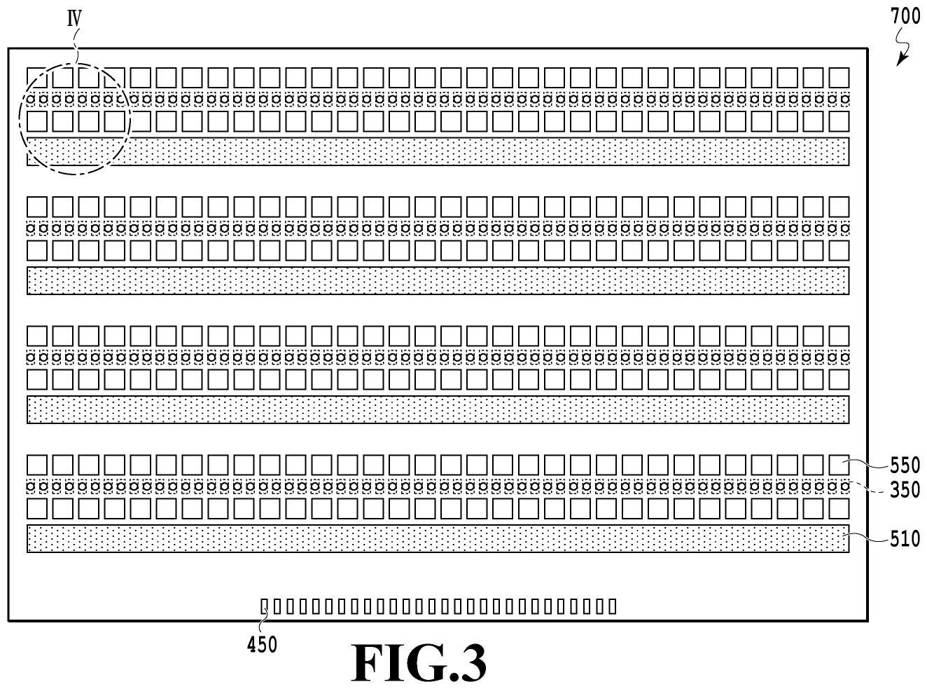

FIG. 3 is a plan view showing a layout configuration of an element board 700 mounted in the printing head 3. The plane of the element board 700 shown in FIG. 3 has a rectangular shape, and the element board 700 includes a plurality of pads 450 along a long side of the rectangular plane of the element board 700. Data and drive voltage are supplied from the outside (the main body part of the printing apparatus) via these pads 450. Then, a plurality of heaters 350, a plurality of ink supply ports 550, and a plurality of switching elements 510 are arrayed in the direction of the long side of the element board 700.

In the example shown in FIG. 3, four heater (350) arrays, four ejection port (420) arrays, eight ink supply port (550) arrays, and four switching element (510) arrays are provided. In addition, on both sides of each of the four heater arrays, ink supply port arrays are formed, and inks of magenta (M), cyan (C), yellow (Y), and black (K) are supplied respectively to the four ink supply port arrays.

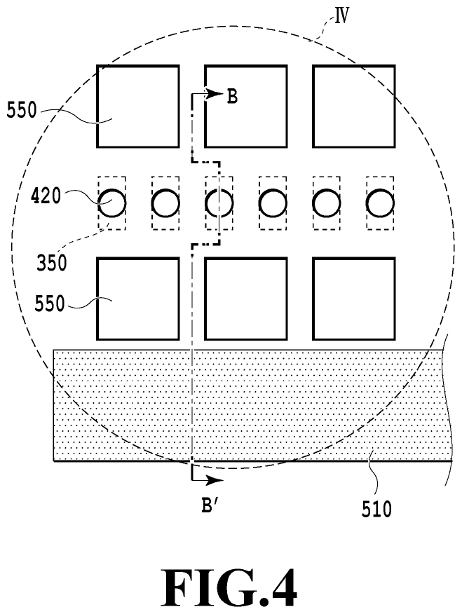

FIG. 4 is an enlarged view of an X portion shown in FIG. 3. As shown in FIG. 4, an ejection port 420 from which ink droplets are ejected is provided to correspond to each heater 350. On both sides of each ejection port array, the ink supply ports 550 for driving the corresponding heaters 350 are provided.

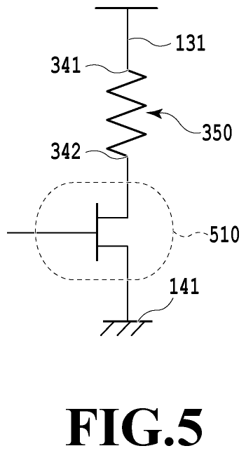

FIG. 5 is a diagram showing an equivalent circuit of a drive circuit which drives one heater. As shown in FIG. 5, a connection portion 341 on one side of the heater (heating resistor) 350 is electrically connected to a VH common wiring 131 for supplying a voltage. Moreover, another connection portion 342 of the heater 350 is electrically connected to a GND common wiring 141 via a switching element 510 (driver) for switching on and off of the drive of the heater 350. The switching element 510 is a MOSFET in this embodiment, and a drive voltage is applied to the gate of the MOSFET from the outside to switch on and off, thereby driving the heater 350.

Next, an embodiment of an element board mounted in the printing head of the printing apparatus having the above-described configuration will be described. Here, as Comparative Example, an element board having the conventional configuration will be described.

### Comparative Example and its Problem

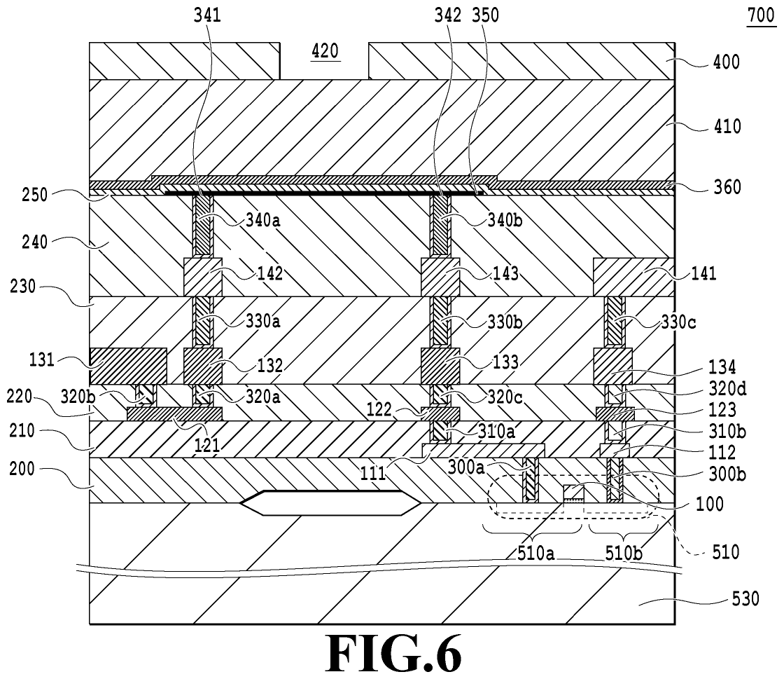

FIG. 6 is a sectional view showing a multi-layer structure of an element board as Comparative Example. FIG. 6 is a sectional view taken along B-B′ shown in FIG. 4. As shown in FIG. 6, a Poly-Si layer 100, wiring layers 110, 120, 130, and 140, a heater 350, as well as an anti-cavitation layer 360 are formed on a Si wafer 530. The Poly-Si layer and each wiring layer and the heater are insulated with insulating layers 200, 210, 220, 230, 240, and 250 in order from the lower layer to the upper layer. In addition, through-holes 300, 310, 320, 330, and 340 which penetrate the insulating layers are formed to electrically connect the wirings.

The connection portion 341 of the heater 350 is connected from a through-hole 340a to a wiring 142, which is formed of the wiring layer 140, to a wiring 132, which is formed of the wiring layer 130, via a through-hole 330a, and to a wiring 121, which is formed of the wiring layer 120, via a through-hole 320a. Moreover, the connection portion 341 is connected from the wiring 121 to the VH common wiring 131, which is formed of the wiring layer 130, via a through-hole 320b. Here, the wiring 132 is provided in such a manner as to be separated individually for each heater, unlike the VH common wiring 131. Hence, the wiring 132 is also referred to as an individual wiring. The VH common wiring 131 is electrically connected to parts of the pads 450 of the element board 700, and is supplied with a voltage from the outside. On the other hand, the GND common wiring 141 is formed in the wiring layer 140, which is different from the VH common wiring 131.

Hence, the elements are connected between the different layers via the through-holes in order to connect the VH common wiring 131 as shown in FIG. 5 to one end of the heater 350, further to connect the other end of the heater 350 to the switching element 510, and to connect the switching element 510 to the GND common wiring 141.

Note that in the element board 700, a plurality of the heaters 350 are formed in the same layer, and the layer in which the plurality of heaters are formed is also referred to as a heater layer.

The connection portion 342 on the other side of the heater 350 is connected from a through-hole 340b to a wiring 143, which is formed of the wiring layer 140, and to a wiring 133, which is formed of the wiring layer 130, via a through-hole 330b. Subsequently, the connection portion 342 is connected to a through-hole 320c, and is connected to one side (510a) of the switching element sequentially via a wiring 122, which is formed of the wiring layer 120, a through-hole 310a, a wiring 111, which is formed of the wiring layer 110, and a through-hole 300a.

Moreover, the other side (510b) of the switching element is connected to a wiring 112, which is formed of the wiring layer 110, via a through-hole 300b. Subsequently, the other side (510b) is connected to a through-hole 310b, and is connected to the GND common wiring 141, which is formed of the wiring layer 140 sequentially via a wiring 123, which is formed of the wiring layer 120, a through-hole 320d, a wiring 134, which is formed of the wiring layer 130, and a through-hole 330c.

Above the heater 350, an ink chamber 410 is provided. Once the switching element 510 is turned on in accordance with data supplied from the outside, current flows through the heater 350, the ink is foamed by the heat of the heater, and the ink is thus discharged from the ejection ports 420 formed in a top plate 400 of the element board.

The wiring layers 110, 120, 130, and 140 are formed of aluminum or an alloy containing aluminum (such as AlSi or AlCu). The wiring layers 110 and 120 are wiring layers which form signal wirings to be used mainly for data transfer. The wiring layer 130 is a wiring layer which forms the VH common wiring 131, and the wiring layer 140 is a wiring layer which forms the GND common wiring 141. The wiring layers 110 and 120 are for data transfer, and are formed to have relatively thin film thicknesses because the flowing current is small, and the wiring layers 110 and 120 are less likely to be affected by the wiring resistance. On the other hand, the wiring layers 130 and 140 are formed to have relatively thick film thicknesses because the wiring layers 130 and 140 are used to cause the current to flow through the heaters, the flowing current is thus large, and the wiring layers 130 and 140 are more likely to be affected by the wiring resistance. Hence, the insulating layers 210 and 220 which cover the wiring layers 110 and 120 are formed to have relatively thin film thicknesses, while the insulating layers 230 and 240 which cover the wiring layers 130 and 140 are formed to have relatively thick film thicknesses.

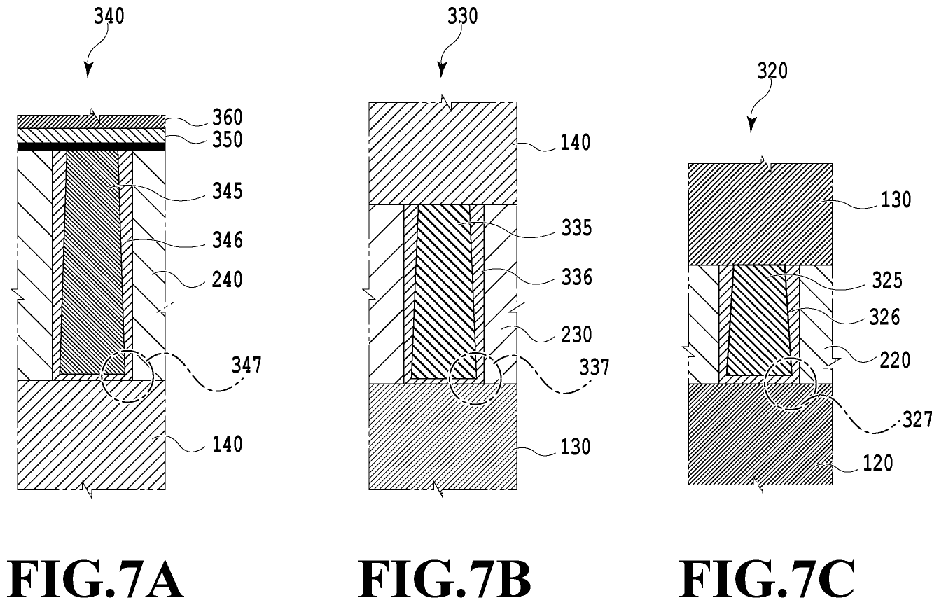

FIGS. 7A to 7C are sectional views showing detailed structures of three through-holes.

The three through-holes shown in FIGS. 7A to 7C are the three through-holes 340, 330, and 320 shown in FIG. 6. FIGS. 7A, 7B, and 7C show the structures of the through-hole 340, the through-hole 330, and the through-hole 320, respectively.

The through-hole 340 shown in FIG. 7A is formed to penetrate the insulating layer 240 on the wiring layer 140. Around a metal plug 345 filling inside the through-hole 340, a barrier metal layer 346 is formed. That is, the barrier metal layer 346 is formed on a bottom surface portion and a side surface portion of a space inside the through-hole 340, and the metal plug 345 is formed inside a space where the barrier metal layer 346 is not provided inside the space in the through-hole 340. The metal plug 345 is generally formed of tungsten, and the barrier metal layer 346 is formed of, for example, titanium Ti or a material containing Ti (such as TiN). 347 indicates a corner portion of the metal plug 345.

The through-hole 330 shown in FIG. 7B is formed to penetrate the insulating layer 230 on the wiring layer 130. Around a metal plug 335 filling inside the through-hole 330, a barrier metal layer 336 is formed. That is, the barrier metal layer 336 is formed on a bottom surface portion and a side surface portion of a space inside the through-hole 330, and the metal plug 335 is formed inside a space where the barrier metal layer 336 is not provided inside the space in the through-hole 330. The metal plug 335 is generally formed of tungsten, and the barrier metal layer 336 is formed of, for example, titanium Ti or a material containing Ti (such as TiN). 337 indicates a corner portion of the metal plug 335.

The through-hole 320 shown in FIG. 7C is formed to penetrate the insulating layer 220 on the wiring layer 120. Around a metal plug 325 filling inside the through-hole 320, a barrier metal layer 326 is formed. That is, the barrier metal layer 326 is formed on a bottom surface portion and a side surface portion of a space inside the through-hole 320, and the metal plug 325 is formed inside a space where the barrier metal layer 326 is not provided inside the space in the through-hole 320. The metal plug 335 is generally formed of tungsten, and the barrier metal layer 326 is formed of, for example, titanium Ti or a material containing Ti (such as TiN). 327 indicates a corner portion of the metal plug 325.

There is a case where an accidental wire break of the heater 350 occurs in the element board 700. In the case where wire break has occurred, part of the anti-cavitation layer 360, which has ink resistance, is lost on the heater 350, and the metal plug 345, which is formed of tungsten, is exposed to the ink. Even in the case where no potential is applied to tungsten, metal dissolution due to the ink progresses. Moreover, since the connection portion 341 is actually electrically connected to the VH common wiring 131 (high potential), there is a possibility that dissolution of the metal plug 345 further progresses.

Here, since the barrier metal layer is less likely to be dissolved into an ink than tungsten, the progress of dissolution is suppressed by the barrier metal layer under ordinary circumstances. However, in the case where the aspect ratio of the through-hole is large, a film-forming material forming the barrier metal layer is less likely to reach a corner portion (the corner portion 347 in FIG. 7A) of the through-hole. For this reason, the film thickness of the barrier metal layer is likely to be thin at the corner portion of the through-hole, so that the film thickness of the barrier metal layer becomes insufficient and dissolution due to the ink progresses in some cases. There is a possibility that a similar incident occurs in the through-hole 330 as well.

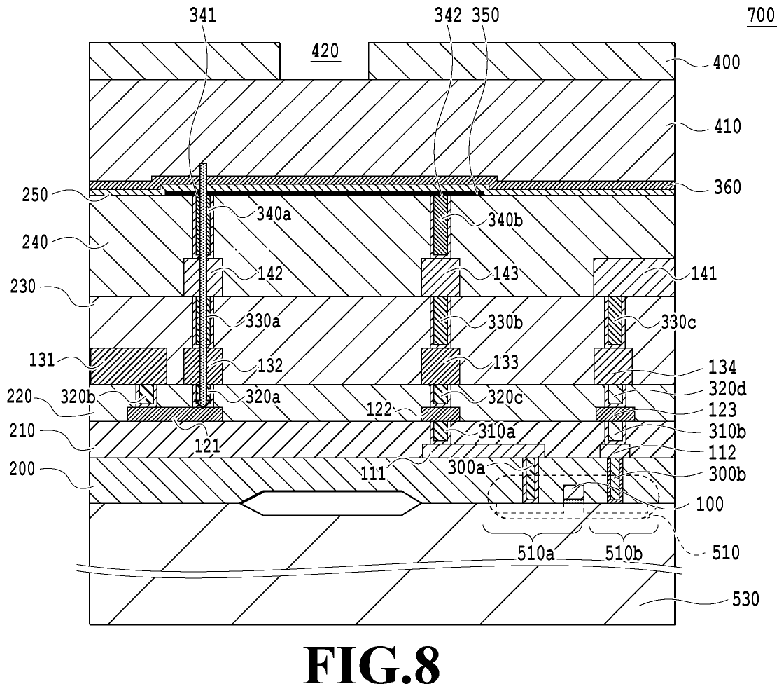

FIG. 8 is a sectional view taken along B-B′ shown in FIG. 4 in the case where corrosion of a wiring layer of an element board progressed. Note that in FIG. 8, the same constituent as that already described with reference to FIG. 6 is denoted by the same reference sign, and the description thereof is omitted.

As indicated by an arrow in FIG. 8, dissolution progresses from a corner portion (the corner portion 347 in FIG. 7A) of the through-hole 340 to penetrate a barrier metal layer (the barrier metal layer 346 in FIG. 7A). The ink which penetrated the barrier metal layer dissolves the wiring 142, and dissolution progresses in the same manner in the through-hole 330 as well.

Here, if the through-hole 320 and the through-hole 330 are compared, the through-hole 330 has a larger aspect ratio, and the film thickness of the barrier metal layer 336 is likely to be thinner at the corner portion 337, so that the coverability is relatively poor. Note that regarding the through-hole 340 as well, the aspect ratio is larger than the through-hole 320 like the through-hole 330, so that the coverability of the barrier metal layer 346 is relatively poor. On the other hand, the through-hole 320 has a small aspect ratio, so that the coverability of the barrier metal layer 326 is favorable at the corner portion 327 as well. Therefore, in the through-hole 320, the ink is unlikely to penetrate from the corner portion 327 into the wiring layer 120, so that the progress of dissolution can be suppressed.

However, in the case of further reducing the sizes of elements, connection members such as plugs are also reduced in size in conjunction with the reduction in size of wirings, which reduces the through-hole diameter, so that the aspect ratio of the through-holes increases. That is, there is a possibility that the coverability of the barrier metal layer at a corner portion of a through-hole becomes poor, and the ink penetrates from a portion where the coverability is insufficient, so that dissolution of a wiring progresses.

In this way, essentially, since a barrier metal layer having a high corrosion resistance to an ink is formed on a side wall portion and a bottom surface portion of a through-hole in which a plug is formed, the progress of the corrosion of a wiring portion described in the above Background Art is stopped by the plug. However, according to the study conducted by the present inventors, in the case where the aspect ratio of a through-hole increases due to a reduction in size of an element, the coverability of the barrier metal layer becomes poor. In this case, there is a possibility that the ink penetrates from a portion where the coverability is insufficient like the vicinity of the corner portion of the bottom portion of the plug into the wiring portion, and the wiring corrosion progresses. It is desired to take measures to suppress or prevent the progress of corrosion as described above.

### <Structure of Element Board According to First Embodiment>

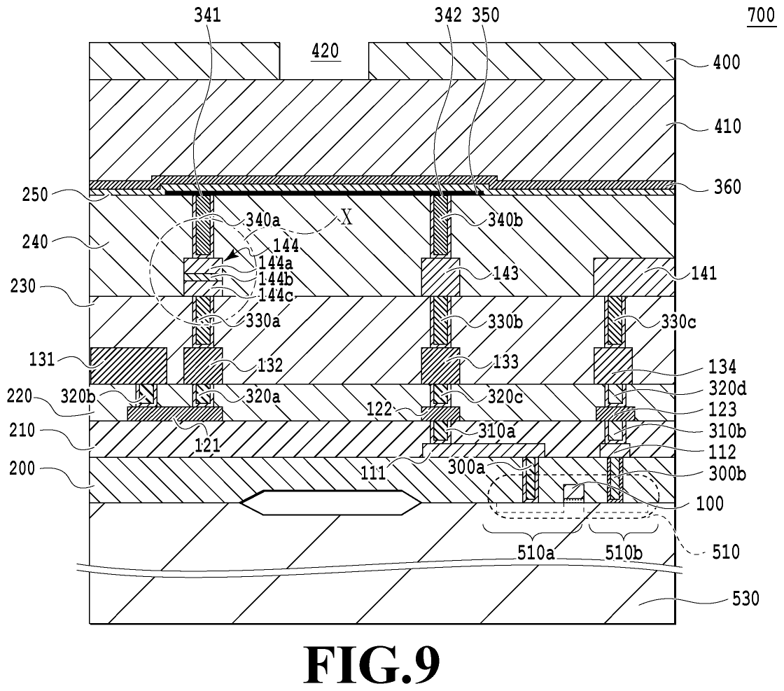

FIG. 9 is a sectional view showing a multi-layer structure of an element board according to the first embodiment. Note that in FIG. 9, the same constituent as that already described with reference to FIG. 6 and FIG. 8 is denoted by the same reference sign, and the description thereof is omitted.

As shown in FIG. 9, the connection portion 341 of the heater 350 is connected from the through-hole 340a to the wiring 132, which is formed of the wiring layer 130, via a stacked structure portion 144, which is formed separately from the wiring layer 140, and the through-hole 330a.

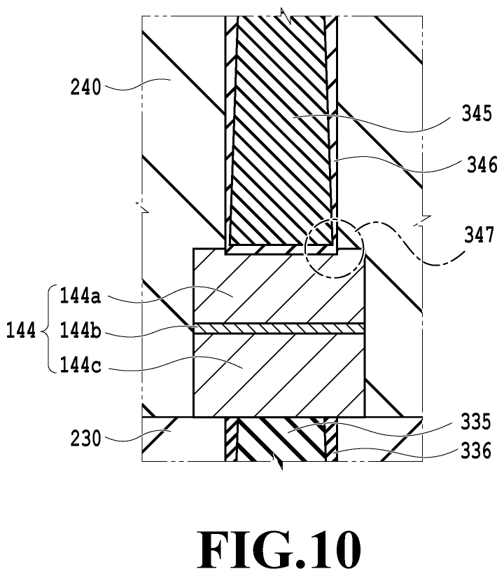

FIG. 10 is an enlarged view of an X portion of the element board shown in FIG. 9. Note that in FIG. 10, the same constituent as that already described with reference to FIG. 6, FIG. 7, FIG. 8, and FIG. 9 is denoted by the same reference numeral, and the description thereof is omitted.

As shown in FIG. 10, the stacked structure portion 144 has a stacked structure in which a conductive layer 144a, a corrosion-resistant conductive layer 144b, and a conductive layer 144c are stacked from the upper layer. The conductive layers 144a and 144c are formed of aluminum or an alloy containing aluminum (AlSi, AlCu, or the like). As a conductive material which can be used for the corrosion-resistant conductive layer 144b, for example, there are metal nitrides such as titanium nitride (TiN) and tantalum nitride (TaN), and these are materials used in semiconductor manufacturing steps as barrier metals in general. For this reason, these can be easily incorporated in a manufacturing process of an element board, and are particularly easily applied because these are conductive films having high corrosion resistances. In addition, besides, a nitride film formed of zirconium nitride, niobium nitride, vanadium nitride, or tungsten nitride, or an alloy such as TaSiN, TiSiN, or WSiN can also be used. Besides, metal elements which are unlikely to be dissolved in an ink even in the case where a voltage is applied thereto, such as titanium and tantalum, can also be used.

In the stacked structure as shown in FIG. 10, since the corrosion-resistant conductive layer 144b is formed on a flat face of the conductive layer 144c, the coverability becomes favorable as compared with a barrier metal layer formed in a through-hole. Note that the film thickness of the corrosion-resistant conductive layer 144b is preferably 20 nm or more in order to suppress wiring dissolution due to the ink. On the other hand, the film thickness of the corrosion-resistant conductive layer 144b is preferably 70 nm or less in order to suppress an increase in wiring resistance.

According to the configuration of the above-described embodiment, the connection portion 341 of the heater 350 is electrically connected to the VH common wiring 131 via the stacked structure portion 144 including the corrosion-resistant conductive layer 144b. Note that although in the present embodiment, the stacked structure portion including the corrosion-resistant conductive layer is formed in the wiring layer 140, the stacked structure portion may be formed in any wiring layer as long as it is between the heater and the VH common wiring. By providing the stacked structure portion in a wiring layer close to the heater, the progress of dissolution can be suppressed in an early stage.

In the configuration shown in FIG. 10, the stacked structure portion is a wiring having a three-layer configuration in which the corrosion-resistant conductive layer 144b is disposed between the conductive layer 144a and the conductive layer 144c. On the other hand, it can also be considered that the progress of wiring dissolution can be suppressed by forming a stacked structure portion as a wiring having a two-layer configuration of a corrosion-resistant conductive layer and a conductive layer. As such a two-layer configuration, a configuration (hereinafter, a two-layer configuration A) in which a corrosion-resistant conductive layer is disposed in an upper layer and a conductive layer is disposed in a lower layer, and a configuration (a two-layer configuration B) in which a conductive layer is disposed in an upper layer and a corrosion-resistant conductive layer is disposed in a lower layer can be considered.

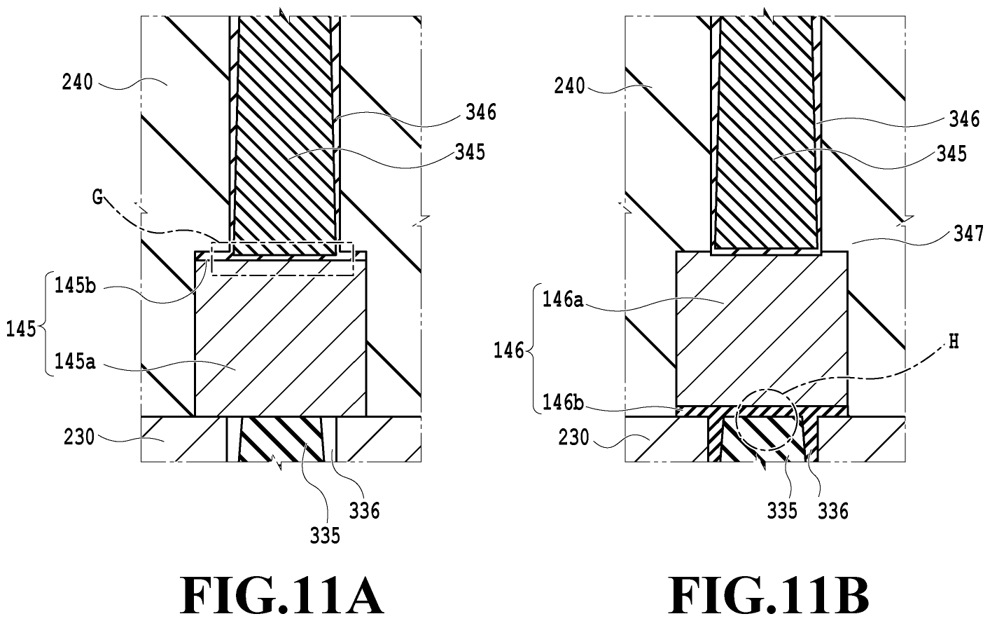

FIGS. 11A and 11B show sectional views of the two-layer configuration A and the two-layer configuration B. Note that in FIGS. 11A and 11B, the same constituent as that already described with reference to FIG. 6, FIG. 7, FIG. 8, FIG. 9, and FIG. 10 is denoted by the same reference numeral, and the description thereof is omitted.

First, in the two-layer configuration A as shown in FIG. 11A, in the case of forming a through-hole by etching, a corrosion-resistant conductive layer is also etched by etching (a G portion in FIG. 11A). As a result, there is a possibility that the coverability of the corrosion-resistant conductive layer decreases, and a sufficient effect in suppression of wiring dissolution cannot be obtained. By increasing the film thickness of the corrosion-resistant conductive layer, it is possible to ensure the coverability even in the case where the corrosion-resistant conductive layer is etched at the time of forming a through-hole. However, there is also a concern that the wiring resistance increases along with the increase in film thickness of the corrosion-resistant conductive layer. On the other hand, in the three-layer configuration shown in FIG. 9, there is no possibility that the coverability of the corrosion-resistant conductive layer 144b decreases by etching.

In addition, in the two-layer configuration B as shown in FIG. 11B, a through-hole is disposed in a lower layer of a corrosion-resistant conductive layer. There is a case where a seam is generated in the case of forming a metal which fills the inside of a through-hole (an H portion in FIG. 11B). There is a possibility that the seam lowers the flatness of a surface on which a corrosion-resistant conductive layer is formed, so that the coverability of the corrosion-resistant conductive layer is also lowered. In the two-layer configuration B as well, by increasing the film thickness of the corrosion-resistant conductive layer, it is possible to ensure the coverability as in the case of the two-layer configuration A. However, there is also a concern that the wiring resistance increases along with the increase in film thickness of the corrosion-resistant conductive layer. On the other hand, in the three-layer configuration shown in FIG. 9, since the corrosion-resistant conductive layer 144b is formed on the relatively flat conductive layer 144c, there is no influence of seams.

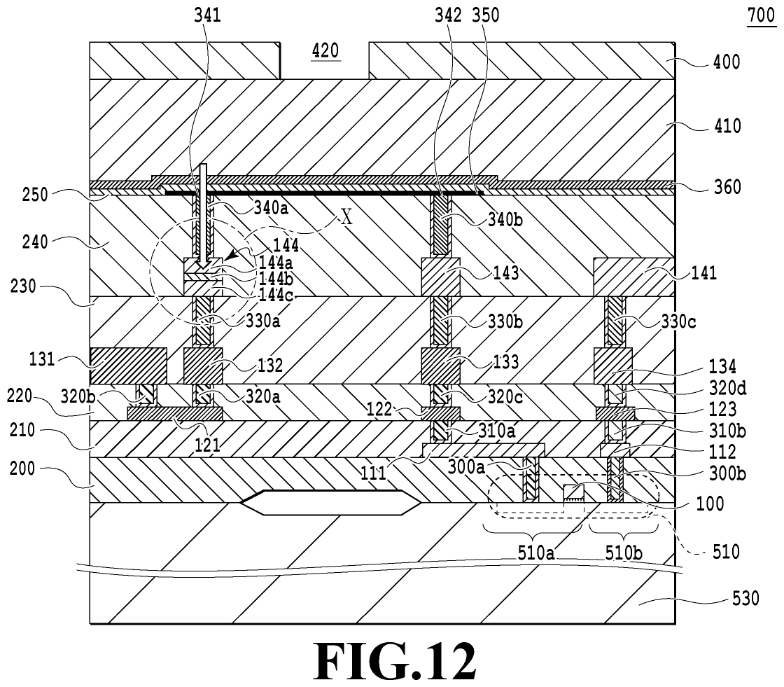

FIG. 12 is a diagram schematically showing how a plug was dissolved by a wire break of a heater of the element board shown in FIG. 9.

As indicated by an arrow in FIG. 12, even if wire break occurred in the heater to cause the ink to penetrate the corner portion 347 of the through-hole 340a shown in FIG. 10, so that dissolution of the plug reached the stacked structure portion 144, it is possible to suppress the progress of the dissolution with the corrosion-resistant conductive layer 144b having a favorable coverability.

### <Structure of Element Board According to Second Embodiment>

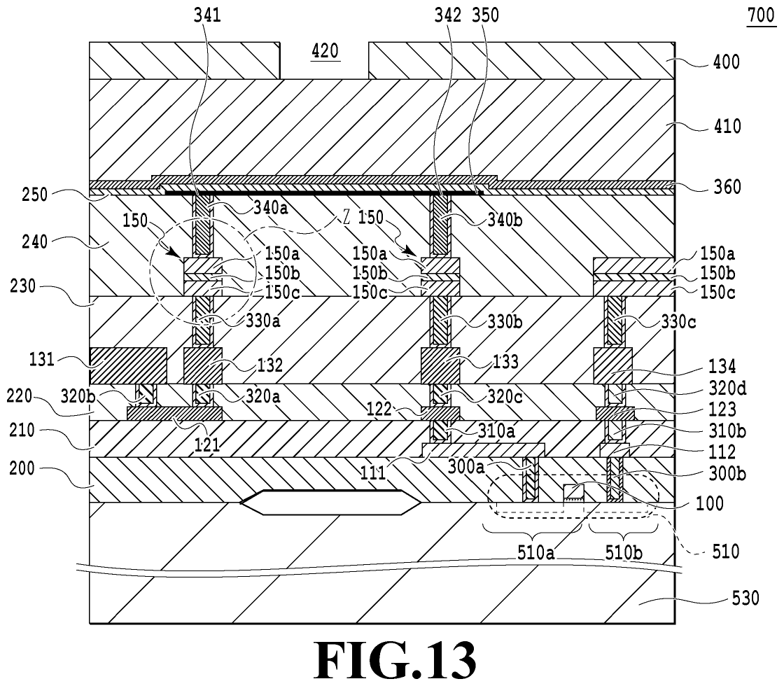

FIG. 13 is a sectional view showing a multi-layer structure of an element board according to a second embodiment. Note that in FIG. 13, the same constituent as that already described with reference to FIG. 6, FIG. 8, FIG. 9, and FIG. 10 is denoted by the same reference numeral, and the description thereof is omitted. Here, characteristic configurations of the second embodiment will be described.

In this second embodiment, stacked structure portions 150 are formed with the same structure as the stacked structure portion 144 shown in FIG. 10. That is, the stacked structure portions 150 each including conductive layers 150a to 150c are formed in the same manner as the stacked structure of the conductive layer 144a, the corrosion-resistant conductive layer 144b, and the conductive layer 144c shown in FIG. 10. Note that the Z portion shown in FIG. 13 has completely the same structure as that in FIG. 10 except for the numerals, and is thus not shown.

In the first embodiment, the wirings 141 and 143 as well as the stacked structure portion 144 are separately formed. On the other hand, in the second embodiment, since the stacked structure portions 150 are collectively formed, the number of manufacturing steps can be reduced as compared with the first embodiment.

In the configuration of the second embodiment as well, even if wire break occurred in the heater to cause the ink to penetrate the corner portion 347 of the through-hole 340a shown in FIG. 13, so that dissolution of the plug reached the stacked structure portion 150, it is possible to suppress the progress of the dissolution with the corrosion-resistant conductive layer 150b having a favorable coverability as in the case of the first embodiment. In addition, even if wire break occurred between the heater layer and the switching element and between the switching element and the GND common wiring, so that dissolution of the plug progressed, the corrosion-resistant conductive layer 150b of the stacked structure portion 150 can suppress the progress of the dissolution.

### <Structure of Element Board According to Third Embodiment>

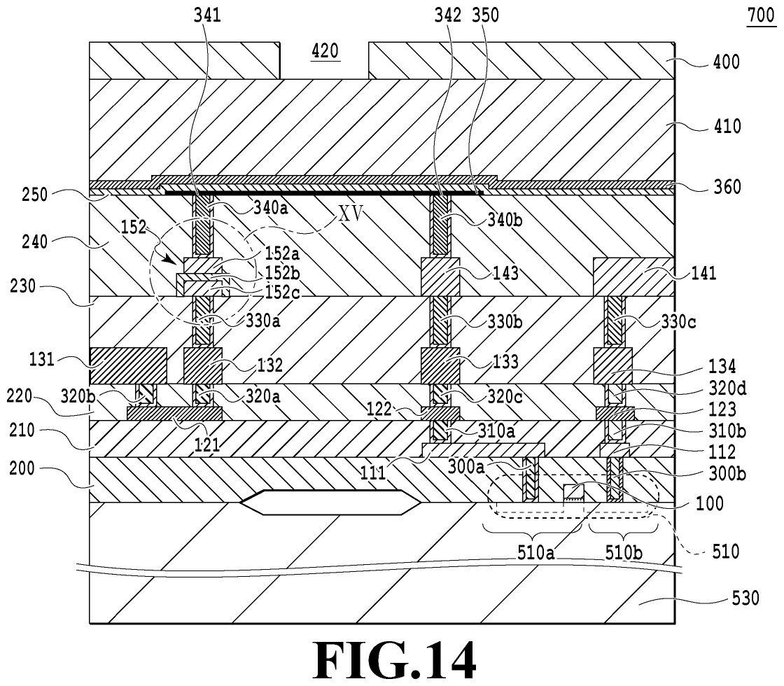

FIG. 14 is a sectional view showing a multi-layer structure of an element board according to a third embodiment. Note that in FIG. 14, the same constituent as that already described with reference to FIG. 6, FIG. 8, FIG. 9, FIG. 10, and FIG. 13 is denoted by the same reference numeral, and the description thereof is omitted. Here, characteristic configurations of the third embodiment will be described.

In this third embodiment, a stacked structure portion 152 is formed separately from the wiring layer 140.

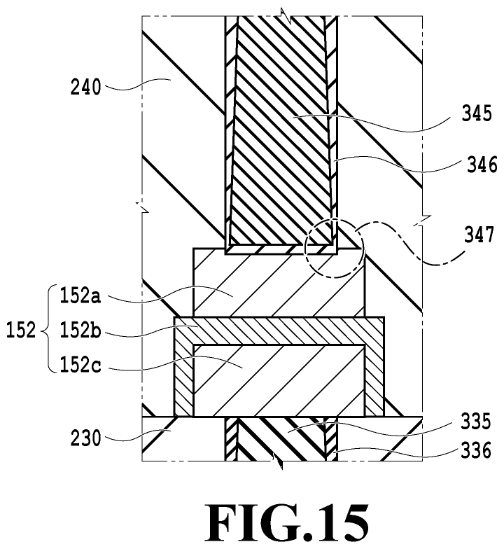

FIG. 15 is an enlarged view of an XV portion of the element board shown in FIG. 14. Note that in FIG. 15, the same constituent as that already described with reference to FIG. 6, FIG. 7, FIG. 8, FIG. 9, FIG. 10, and FIG. 13 is denoted by the same reference numeral, and the description thereof is omitted.

In the third embodiment, as shown in FIG. 15, the stacked structure portion 152 has a stacked structure in which a conductive layer 152a, a corrosion-resistant conductive layer 152b, and a conductive layer 152c are sequentially stacked, in which the corrosion-resistant conductive layer 152b is formed also on a side surface of the conductive layer 152c. The conductive layers 152a and 152c are formed of aluminum or an alloy containing aluminum (AlSi, AlCu, or the like). As a conductive material which can be used for the corrosion-resistant conductive layer 152b, for example, there are metal nitrides such as titanium nitride (TiN) and tantalum nitride (TaN), and these are materials used in semiconductor manufacturing steps as barrier metals in general. For this reason these can be easily incorporated in a manufacturing process of an element board, and are particularly easily applied because these are conductive films having high corrosion resistances. In addition, besides, a nitride film formed of zirconium nitride, niobium nitride, vanadium nitride, or tungsten nitride, or an alloy such as TaSiN, TiSiN, or WSiN can also be used. Besides, metal elements which are unlikely to be dissolved in an ink even in the case where a voltage is applied thereto, such as titanium and tantalum, can also be used.

In the stacked structure as shown in FIG. 15, since the corrosion-resistant conductive layer 152b is formed on a flat face of the conductive layer 152c, the coverability becomes favorable as compared with a barrier metal layer formed in a through-hole. In addition, as compared with the element boards of the first embodiment and the second embodiment, since the present embodiment has the configuration in which the corrosion-resistant conductive layer covers the side surface of the conductive layer below the corrosion-resistant conductive layer, the corrosion-resistant conductive layer extends from the side surface and can suppress the progress of dissolution of the plug. Therefore, as compared with the element boards of the first embodiment and the second embodiment, the present embodiment has a configuration which is further secure against the progress of dissolution of the plug. Although the embodiment shown in FIG. 15 has the structure in which the corrosion-resistant conductive layer is formed also on the side surface of the conductive layer 152c, the corrosion-resistant conductive layer may be formed on a side surface of the conductive layer 152a, or may be formed on the side surfaces of both of the conductive layer 152a and the conductive layer 152c.

Note that in the above-described embodiments, the element board for use in a printing head which ejects an ink in a printing apparatus has been described as examples. However, the present disclosure is not limited to this. The present disclosure is applicable to apparatuses such as a printer, a copier, a facsimile having a communication system, and a word processor having a printer unit, and further an industrial printing apparatus combined with various processing apparatuses in a complex manner. In addition, the element board of the present disclosure can also be used in, for example, printing apparatuses for use in applications such as fabrication of biochips, electronic circuit printing, and manufacture of color filters.

According to the present disclosure, the progress of wiring corrosion can be suppressed by a wiring having a corrosion-resistant conductive layer even in the case where an ink penetrates into a portion having a poor coverability in a barrier metal layer of a through-hole.

The present disclosure is not limited to the above-described embodiments, and various changes and modifications can be made without departing from the spirit and scope of the present invention. Therefore, claims are attached to publish the scope of the present invention.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-144432, filed Aug. 26, 2024, which is hereby incorporated by reference herein in its entirety.

What is claimed is:

1. An element board having a multi-layer structure, comprising:
a heater layer in which a plurality of heaters for ejecting a liquid are formed;
a first wiring layer which has a stacked structure portion of three or more layers sequentially stacked in a conduction direction at least in part thereof,
a first metal plug which is in contact with the stacked structure portion, and fills an inside of a first through-hole extending toward the heater layer;
a second metal plug which is in contact with the stacked structure portion, and fills an inside of a second through-hole extending toward an opposite side from the heater layer; and
a second wiring layer in which a common wiring for supplying a voltage to the plurality of heaters from an outside is formed, wherein
the plurality of heaters are connected to the common wiring through the first wiring layer,
the stacked structure portion includes a corrosion-resistant conductive layer, a first conductive layer, and a second conductive layer,
a surface of the corrosion-resistant conductive layer on the heater layer side is in contact with the first conductive layer,
a surface of the corrosion-resistant conductive layer on the opposite side from the heater layer is in contact with the second conductive layer,
the first metal plug is in contact with the first conductive layer,
the second metal plug is in contact with the second conductive layer,
the first wiring layer is electrically connected to the heater layer through the first metal plug, and is electrically connected to the common wiring through the second metal plug, and
the corrosion-resistant conductive layer is formed of a material having a high corrosion resistance to an ink.

2. The element board according to claim 1, wherein the corrosion-resistant conductive layer is formed also on a surface facing in a direction different from a stacking direction of the first conductive layer and/or the second conductive layer.

3. The element board according to claim 1, wherein the first conductive layer and the second conductive layer contain aluminum.

4. The element board according to claim 1, wherein the corrosion-resistant conductive layer is formed of any material of TiN, TiW, TaN, TaSiN, TiSiN, WSiN, Ti, and Ta.

5. The element board according to claim 1, comprising the corrosion-resistant conductive layer which has a thickness of 20 nm or more in a stacking direction.

6. The element board according to claim 1, comprising the corrosion-resistant conductive layer which has a thickness of 70 nm or less in a stacking direction.

7. The element board according to claim 1, further comprising a switching element which is electrically connected to the heater layer, wherein the stacked structure portion is further included between the heater layer and the switching element.

8. The element board according to claim 1, further comprising a third wiring layer which has a GND common wiring electrically connected to the heater layer, wherein the stacked structure portion is further included between the heater layer and the GND common wiring.
